(19) United States
(12) Patent Application Publication
(10) Pub. No.: US 2002/0097316 A1
(43) Pub. Date: Jul. 25, 2002

(54) THERMAL IMAGE TRANSFER RECORDING METHOD AND THERMAL IMAGE TRANSFER RECORDING MEDIUM THEREFOR

(75) Inventors: KEIICHI SHIOKAWA, SHIZUOKA (JP); YOSHIAKI YAMADA, SHIZUOKA (JP); YASUMITSU KUGA, SHIZUOKA (JP)

Correspondence Address: CHRISTOPHER C DUNHAM, COOPER AND DUNHAM, 1185 AVENUE OF THE AMERICAS, NEW YORK, NY, 10036

(73) Assignee: RICOH COMPANY, LTD.

(21) Appl. No.: 08/985,951

(22) Filed: Dec. 5, 1997

(30) Foreign Application Priority Data
Dec. 9, 1996 (JP) 8-344576
Dec. 4, 1997 (JP) 09-350025

(51) Int. Cl. B41J 2/325

(52) U.S. Cl. 347/217

(57) ABSTRACT

A thermal image transfer recording method includes the steps of holding a thermal image transfer recording medium having a support and a thermal transfer layer formed thereon and an image receiving member between an edge thermal head for use in a line printer and a platen roller in such a fashion that the thermal transfer layer of the recording medium comes in contact with the image receiving member with the application of a tension to the thermal image transfer recording medium, and transferring an image from the thermal transfer layer of the recording medium to the image receiving member by the application of heat to the recording medium using the thermal head, the thermal image transfer recording medium having a dynamic elasticity modulus in a range of 1×10⁶ to 1×10¹⁰ at 70° C.

### BACKGROUND OF THE INVENTION

1. Field of the Invention

The present invention relates to a thermal image transfer recording method, and a thermal image transfer recording medium comprising a support and a thermal transfer layer formed thereon for use with the above-mentioned recording method, from which recording medium an image can be transferred to an image receiving member by the application of thermal energy to the recording medium, with the thermal transfer layer of the recording medium being in a fused or softened state in the course of image transferring step.

2. Discussion of Background

The thermal image transfer recording method is capable of performing information recording using a sheet of plain paper and a thermal image transfer recording medium such as an ink ribbon under the application of thermal energy. The above-mentioned thermal image transfer recording method is widely used because it can produce images with high image contrast.

For achieving the thermal image transfer recording method, there are employed, for example, a thermal image transfer recording medium (e.g., an ink ribbon), an image-receiving medium (e.g., a sheet of plain paper), a thermal head for applying thermal energy to the thermal image transfer recording medium, and a platen roller. In this case, the ink ribbon is superimposed on a sheet of plain paper in such a fashion that a thermal transfer layer of the ink ribbon comes in contact with the image-receiving surface of plain paper. Ink images are transferred from the ink ribbon to the plain paper by the application of thermal energy to the ink ribbon using the thermal head, with the ink ribbon and the plain paper being held between the thermal head and the platen roller with the static pressure being applied between the thermal head and the platen roller. Generally, the thermal head for use with the above-mentioned thermal image transfer recording method comprises a ceramic support and a hybrid integrated circuit of large scale integration (LSI) formed on the support, provided with heating resistors for converting the recording signal into the thermal energy, and latches and drivers for signal lines.

There is commonly employed a serial printer or line printer to output the recording image by the above-mentioned thermal image transfer recording method.

In the case where the serial printer is employed, image printing is carried out as illustrated in FIG. 1. To be more specific, images are transferred from an ink ribbon 30 to an image receiving sheet 8 by transporting the ink ribbon 30 in the direction of an arrow (a) and scanning a thermal head 60 in the direction perpendicular to the transporting direction of the image receiving sheet 8, indicated by an arrow (b). For instance, after the images for, at least, one line have been completely printed on the image receiving sheet 8, the image receiving sheet 8 is shifted by one line in the direction of the arrow (b). Such image printing operation and transporting operation of the image receiving sheet are serially repeated.

In the operation of the above-mentioned serial printer, the ink ribbon 30 and the thermal head 60 are always at a distance from the image receiving sheet 8 when the image printing operation is not carried out. Therefore, the serial printer cannot produce high quality images unless the paper transportation accuracy is remarkably high.

On the other hand, when the image printing is carried out by use of the line printer, both a thermal head 60 and a thermal image transfer recording medium (ink ribbon) 30 have a width which is the same or larger than the predetermined width for printing on an image receiving sheet 8 as shown in FIG. 2. The ink ribbon 30 is superimposed on the image receiving sheet 8 in such a fashion that the thermal transfer layer of the ink ribbon 30 comes in contact with the image receiving sheet 8. To achieve image recording on the image receiving sheet 8, the ink ribbon 30 and the image receiving sheet 8 are held between the thermal head 60 and a platen roller (not shown). Then, for example, the character images composed of dots are transferred from the ink ribbon 30 to the image receiving sheet 8 by the dot so that every character arranged in the same line perpendicular to the transporting direction of the ink ribbon 30 may be printed at once on the image receiving sheet 8 by the application of thermal energy to the ink ribbon 30 using the thermal head 60. Every time such a line of dots is printed on the image receiving sheet 8, the ink ribbon 30 and the image receiving sheet 8 are shifted in the transporting direction of the ink ribbon 30 by a one-dot length. In this case, the ink ribbon 30 and the image receiving sheet 8 are moved while in contact with each other. Namely, in the case of the line printer, the ink ribbon 30 is always brought into contact with the image receiving sheet 8 between the thermal head 60 and the platen roller (not shown) when the image printing is not carried out. Accordingly, the transportation accuracy of the image receiving sheet 8 is remarkably high, so that high quality printed images can be obtained. Therefore, the line printer has become the mainstream in the field of printer in recent years.

FIG. 3A is a perspective view of a conventionally known thermal head. As shown in FIG. 3A, a heating element 401 is disposed on the flat surface of a thermal print head 40 inside from the edge portion by a distance D₁ of about 3 to 10 mm.

When the thermal head as shown in FIG. 3A is used in the thermal image transfer recording method, as illustrated in FIG. 3B, a thermal image transfer recording medium (ink ribbon) 30 is brought into contact with an image receiving member 8, and they travel through a thermal print head 40 and a platen roller 50. In this case, a heating element 401 of the thermal print head 40 is in a plane contact with the ink ribbon 30. The image receiving member 8 comes in contact with the ink ribbon 30 and image recording is performed on the image receiving member 8 at the position where the platen roller 50 is in contact with the heating element 401 of the thermal print head 40. The distance from this image transfer position to the position where the ink ribbon 30 is separated from the image receiving member 8, that is, a distance indicated by A in FIG. 3B, is generally as long as 3 to 15 mm. Therefore, there may occur the problem that the ink composition in the thermal transfer layer of the ink ribbon 30 which has been fused by the application of heat thereto by the thermal print head 40 is cooled before transferred to the surface of the image receiving member 8. Namely, the internal temperature of the ink composition which has been once fused is gradually decreased while the ink ribbon 30 passes through the distance A, and finally, lowered to a temperature near the room temperature when the ink composition is transferred to the image receiving member 8. The ink composition cannot be readily transferred to the ink receiving member 8 because of high cohesion of the ink composition. As a result, the image quality of the transferred image is lowered because many void portions are generated in the image transferred to the image receiving member 8 and the resolution of the obtained ink image is poor.

To solve the above-mentioned shortcoming of the conventional thermal head as shown in FIG. 3A, there is the tendency to carry out the thermal image transfer recording by use of a line printer equipped with an edge type thermal head as shown in FIG. 4A.

As shown in FIG. 4A, a heating element 201 is disposed at the edge of the thermal print head 20. Strictly speaking, the distance D₂ as indicated in FIG. 3A is as short as 0.2 mm or less.

When the thermal image transfer recording is carried out using such an edge type thermal head 20 for use in the line printer as shown in FIG. 4A, the distance A is about 80 to 300 μm, preferably about 150 to 250 μm, which is much shorter than the distance A in FIG. 3B. Therefore, the ink composition for use in the thermal transfer layer of the ink ribbon 30, which has been fused by the application of heat thereto, can be readily transferred to the image receiving sheet 8 with the ink composition being maintained at high temperature. As a result, the images can be formed on the image receiving sheet 8 without any void portions.

As previously mentioned, a fused portion of the ink ribbon 30 corresponding to an image portion can be maintained at high temperature when transferred to the image receiving sheet 8. In the ink ribbon 30, there is distinct difference in temperature between the above-mentioned high-temperature portion to be transferred to the image receiving sheet 8 and an unfused portion corresponding to a background portion. Therefore, the boundaries between the high-temperature fused portion and the unfused portion are clear in the ink ribbon 30, so that the high-temperature fused portion can be easily sheared at the boundaries, thereby forming images with sharp edge and high resolution.

However, there has occurred the problem of poor transfer of the fused ink to the image receiving member when the above-mentioned edge type thermal head is employed.

According to the analysis by the inventors of the present invention, the reason for this problem is supposed to be as follows. The length of the edge type thermal head for use in the currently available line printer is in the range of about 5 to 26 cm to cope with the width of the image receiving member, and the width of the thermal image transfer recording medium such as an ink ribbon to be used therewith is corresponding to the above-mentioned length of the edge type thermal head. Immediately after the thermal transfer layer of the ink ribbon is fused by the application of heat thereto using the edge type thermal head, the ink ribbon is pulled up with the application of a tension thereto so as to be wound around a core. In the line printer, since the heating element of the edge type thermal head is in a line contact with the ink ribbon in a direction of the width of the ink ribbon, the tension applied to the ink ribbon in the width direction thereof may differ from place to place when the edge type thermal head is brought into contact with the ink ribbon. Such a variation of the tension applied to the ink ribbon, which is particularly noticeable when the length of the edge type thermal head is increased, unfavorably makes the temperature of the fused ink composition to be transferred to the image receiving member uneven.

This induces the poor transfer of ink composition to the image receiving member. To be more specific, an image will not be at all transferred to the image receiving member, or partially transferred thereto. In addition, it may occur that an ink image cannot be clearly transferred at the starting point of the image printing. This phenomenon occurs within a wide range from a low printing speed to a high printing speed.

Furthermore, there is another problem that the friction resistance and heat resistance of the image transferred by use of the line printer equipped with the above-mentioned edge type thermal head are insufficient. When the thermal transfer layer of the ink ribbon comprises a large amount of a thermoplastic resin, the thermoplastic resin transferred to the image receiving member cannot be completely fixed thereon. This is because when the ink ribbon is separated from the image receiving member after image transfer, the thermoplastic resin for use in the thermal transfer layer transferred to the image receiving member is still at high temperature and simply deposited thereon. Therefore, the image provided with high friction resistance and heat resistance cannot be formed on the image receiving sheet.

### SUMMARY OF THE INVENTION

It is therefore a first object of the present invention to provide a thermal image transfer recording method and a thermal image transfer recording medium for use with the above-mentioned recording method, free from the conventional shortcomings, capable of solving the problem of poor transfer of a thermal transfer layer of the thermal image transfer recording medium which comprises a coloring agent and a thermoplastic resin to the image receiving member when thermal printing is carried out using a line printer equipped with an edge type thermal head.

A second object of the present invention is to provide a thermal image transfer recording method capable of producing sharp images with high resolution onto an image receiving sheet with a low surface smoothness, for example, with a surface smoothness of 1,000 sec or less.

A third object of the present invention is to provide a thermal image transfer recording medium capable of forming ink images with excellent friction resistance and heat resistance.

The above-mentioned first and second objects of the present invention can be achieved by a thermal image transfer recording method comprising the steps of holding a thermal image transfer recording medium comprising a support and a thermal transfer layer formed thereon and an image receiving member between an edge thermal head for use in a line printer and a platen roller in such a fashion that the thermal transfer layer of the recording medium comes in contact with the image receiving member with the application of a tension to the thermal image transfer recording medium, and transferring an image from the thermal transfer layer of the recording medium to the image receiving member by the application of heat to the recording medium using the thermal head, the thermal image transfer recording medium having a dynamic elasticity modulus in a range of 1×10⁶ to 1×10¹⁰ at 70° C.

The above-mentioned first and third objects of the present invention can be achieved by a thermal image transfer recording medium which comprises a support and a thermal transfer layer formed thereon, and has a dynamic elasticity modulus in a range of 1×10⁶ to 1×10¹⁰ at 70° C.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic view in explanation of the thermal image transfer recording operation by use of a serial printer;

FIG. 2 is a schematic view in explanation of the thermal image transfer recording operation by use of a line printer;

FIG. 3A is a schematic perspective view of one conventional type of thermal head;

FIG. 3B is a schematic view which shows the thermal image transfer recording operation by use of the line printer equipped with the conventional thermal head as shown in FIG. 3A;

FIG. 4A is a schematic perspective view of an edge type thermal head for use in a line printer;

FIG. 4B is a schematic view which shows the thermal image transfer recording operation by use of the line printer equipped with the edge type thermal head as shown in FIG. 4A;

FIG. 4C is a schematic diagram in explanation of the relationship between the tension applied to the thermal image transfer recording medium and the shear strength or the peeling strength of the thermal transfer layer of the recording medium;

FIG. 5 is a schematic cross-sectional view of a thermal image transfer recording medium, in explanation of the shear strength and the peeling strength of the thermal transfer layer; and

FIG. 6 is a schematic diagram in explanation of the method of measuring the shear strength and the peeling strength of the thermal transfer layer of the thermal image transfer recording medium.

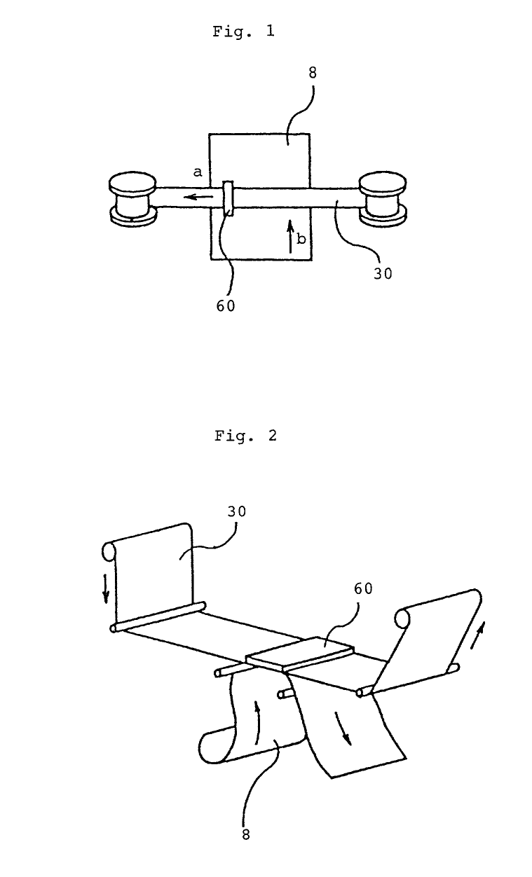

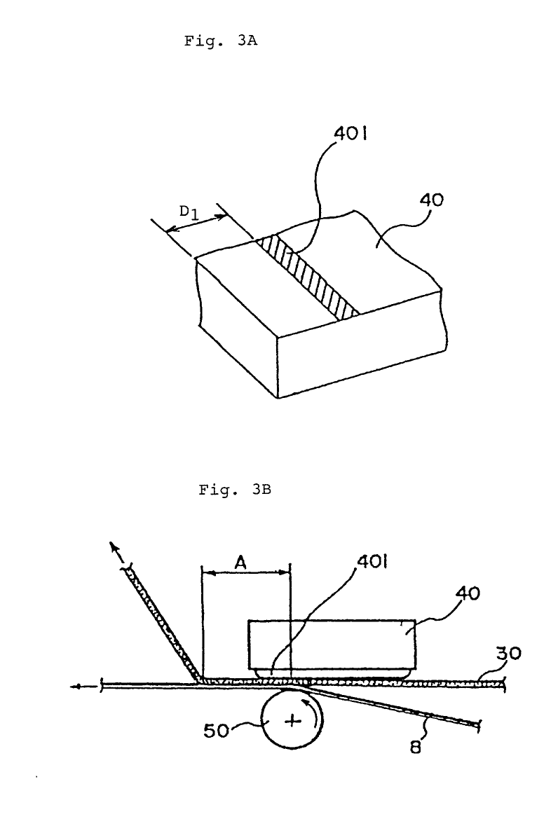

### DESCRIPTION OF THE PREFERRED EMBODIMENTS

The inventors of the present invention have studied and analyzed the relationship between the tension applied to a thermal image transfer recording medium when the printer is driven and the physical strength of the recording medium, and between the thermal characteristics of the thermal transfer layer of the recording medium and the physical properties thereof.

According to the present invention, a thermal image transfer recording method comprises the steps of holding a thermal image transfer recording medium and an image receiving member between an edge type thermal head for use in a line printer and a platen roller in such a fashion that the thermal transfer layer of the recording medium comes in contact with the image receiving member with the application of a tension to the thermal image transfer recording medium, and transferring an image from the thermal transfer layer of the recording medium to the image receiving member by the application of heat to the recording medium using the thermal head. The thermal image transfer recording medium for use with the above-mentioned recording method has a dynamic elasticity modulus in a range of 1×10⁶ to 1×10¹⁰ at 70° C. The above-mentioned temperature 70° C. is a temperature where thermal image transfer is generally carried out.

When the thermal image transfer recording is carried out according to the present invention, the previously mentioned conventional problem of poor transfer of the thermal transfer layer to the image receiving member can be effectively prevented, and at the same time, the thermal transfer layer comprising a thermoplastic resin can be steadily transferred and fixed to the image receiving member.

Furthermore, it is preferable that the tension applied to the thermal image transfer recording medium when the thermal image transfer recording medium is driven be larger than both the peeling strength and the shear strength of the thermal transfer layer of the recording medium.

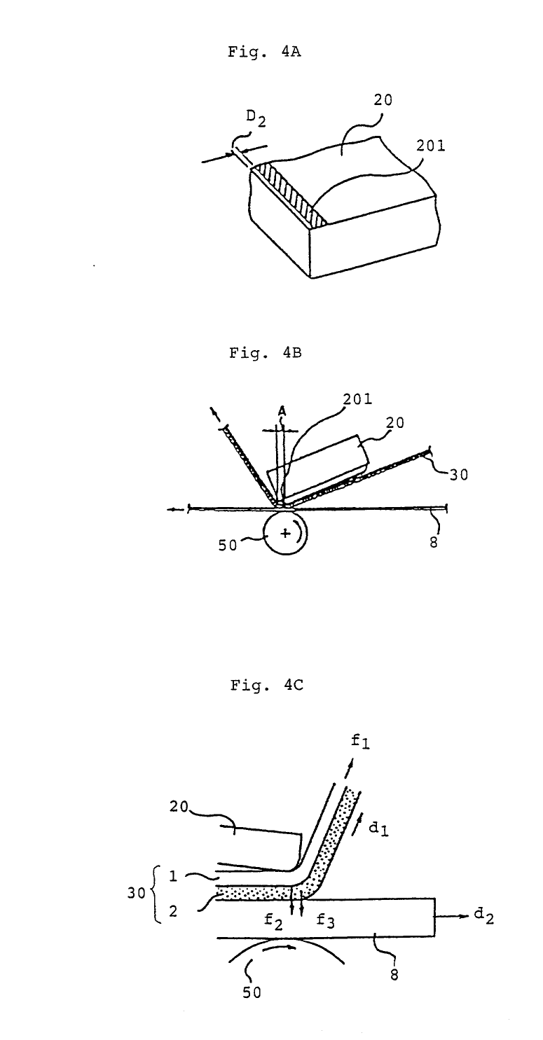

A thermal image transfer recording medium 30 as shown in FIG. 4C which comprises a support 1 and a thermal transfer layer 2 formed on the support 1 is imagewise heated by use of an edge type thermal head 20. In this case, the thermal transfer layer 2 comes in contact with an image receiving member 8 which is urged by a platen roller 50. After the completion of thermal image transfer recording, the thermal image transfer recording medium 30 is separated from the image receiving member 8 and pulled up to a direction of an arrow d₁. A tension (f₁) applied to the recording medium 30 may be adjusted to such a degree that the tension (f₁) becomes larger than both the peeling strength (f₂) and the shear strength (f₃) of the thermal transfer layer 2 of the recording medium 30. When the above-mentioned relationship is satisfied, the fused ink for use in the thermal transfer layer 2 can be readily transferred to the image receiving member 8 when the thermal image transfer recording medium 30 is caused to passe through the thermal head 20. Thus, poor thermal transfer can be effectively prevented.

As previously mentioned, when the tension (f₁) is larger than both the peeling strength (f₂) and the shear strength (f₃) of the thermal transfer layer 2 of the recording medium 30, the timing of the transferring of an image from the thermal transfer layer 2 to the image receiving member 8 can be made constant. Therefore, even though the thermal transfer layer 2 comprises a thermoplastic resin with a high cohesion, the timing of the peeling of the thermal transfer layer 2 from the support 1 of the recording medium 30 can be prevented from varying. As a result, insufficient transfer of the image from the thermal transfer layer can be prevented. In addition, the transferred thermoplastic resin can be so steadily fixed on the image receiving member that the image formed on the image receiving member is excellent in terms of the heat resistance and friction resistance.

According to the present invention, there is provided a thermal image transfer recording medium which comprises a support and a thermal transfer layer thereon, and has a dynamic elasticity modulus in a range of 1×10⁶ to 1×10¹⁰ at 70° C. This thermal image transfer recording medium is particularly effective when used in the thermal image transfer recording process employing the line printer with the previously mentioned edge type thermal head. The thermal image transfer recording method of the present invention can be carried out so long as the image can be transferred from the thermal transfer layer of the thermal image transfer recording medium to the image receiving member with the thermal transfer layer being maintained in a fused or softened state.

In light of the above-mentioned factor, it is desirable that the thermal image transfer recording medium of the present invention comprise a support, a release layer formed thereon which can be easily peeled from the support when heated, and a thermal transfer layer with high cohesion, formed on the release layer, which is not completely melted, but sufficiently softened when heated for image transfer. When this kind of thermal image transfer recording medium is employed, it is easy to satisfy the relationship that the tension applied to the recording medium is larger than both the shear strength and the peeling strength of the thermal transfer layer during the transferring of the image from the thermal transfer layer to the image receiving member under the application of heat thereto.

The method of measuring the tension applied to the thermal image transfer recording medium will be explained in detail. The tension applied to the recording medium can be obtained from the torque and the radius of a core for winding the recording medium therearound, and the width of the recording medium in accordance with the following formula:

$$\begin{matrix}Tension applied to \\ recording medium ( g / cm )\end{matrix} = P ( g \cdot cm ) / I ( cm ) \times W ( cm )$$

wherein P is a torque of the axis of the core; I is a radius of the core; and W is a width of the thermal image transfer recording medium.

Referring now to FIG. 5, a thermal transfer layer 2 is attached to a support 1 in the thermal image transfer recording medium. The shear strength of the thermal transfer layer 2 is a capability of standing the shear stress in the direction of an arrow a; while the peeling strength of the thermal transfer layer 2 is the adhesion strength of the thermal transfer layer 2 to the support 1 when the thermal transfer layer 2 is peeled therefrom in the direction of an arrow β, as illustrated in FIG. 5.

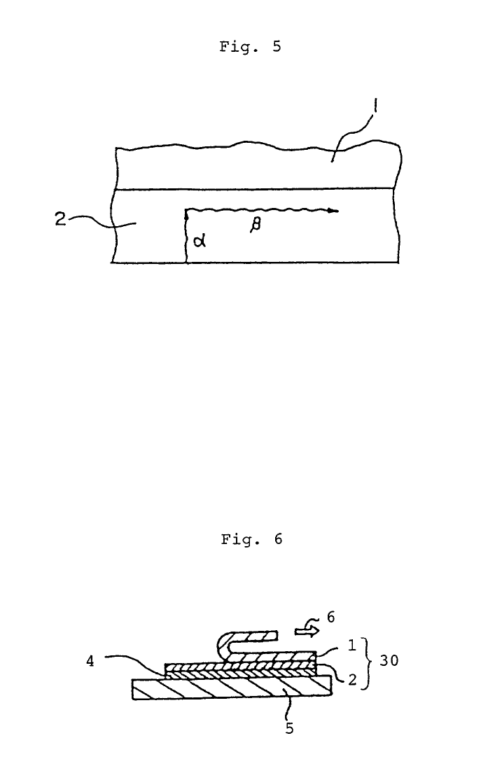

The method of measuring the shear strength and the peeling strength of the thermal transfer layer of the recording medium will be described in detail with reference to FIG. 6.

In FIG. 6, a thermal image transfer recording medium 30 comprises a support 1 and a thermal transfer layer 2 provided on the support 1. The thermal image transfer recording medium 30 is fixed to a temperature-controlled plate 5 in such a manner that the thermal transfer layer 2 is attached to the temperature-controlled plate 5 through an adhesive tape 4. With the temperature of the temperature-controlled plate 5 being set to 70° C, the support 1 is peeled from the thermal transfer layer 2 in a peeling direction 6 at a speed of about 30 cm/sec. At that time, the shear strength and the peeling strength of the thermal transfer layer 2 are measured using a tension gauge. The peak value first read from the tension gauge is regarded as the shear strength, and that read in the peeling operation is regarded as the peeling strength of the thermal transfer layer 2.

In the present invention, the modulus of dynamic elasticity of the thermal image transfer recording medium is measured using a commercially available viscoelasticity measuring apparatus SDM-5600″ (Trademark), made by Seiko Instruments Inc., at 70° C. under the following conditions:

Width of thermal image transfer

| | |
|---|---|
| recording medium: | 20 mm |
| Frequency: | 1, 5, and 10 Hz |
| Measuring temperature range: | 30 to 100° C. |
| Temperature increasing rate: | 2° C./min |

The thermal image transfer recording medium according to the present invention has a dynamic elasticity modulus in the range of 1×10⁶ to 1×10¹⁰ at 70° C. When the dynamic elasticity modulus is within the above-mentioned range, the transfer of an image from the thermal transfer layer to the image receiving member can be efficiently carried out although the cohesion of the thermal transfer layer is high.

In addition, the elasticity behavior of the thermal image transfer recording medium at 70° C. becomes one of the most important factors to determine the image quality of the image transferred to the image receiving member and the heat and friction resistance of the image obtained on the image receiving member.

When the dynamic elasticity modulus is in the range of 1×10⁶ to 1×10¹⁰ at 70° C., satisfactory images can be formed on an image receiving member with low surface smoothness and the obtained image can be provided with the heat resistance and the friction resistance. When the dynamic elasticity modulus is less than 1×10⁶, the softened thermal transfer layer tends to spread or penetrate into the image receiving member. As a result, the image obtained on an image receiving member with low surface smoothness is free from sharpness; while the image formed on an image receiving member with high surface smoothness easily becomes defaced. Further, the heat resistance and the friction resistance of the thus obtained image are poor. On the other hand, when the dynamic elasticity modulus exceeds 1×10¹⁰, it is difficult to carry out the image formation even by the thermal image transfer recording method of the present invention.

Preferably, the dynamic elasticity modulus of the recording medium may be in the range of 1×10⁷ to 5×10⁸ at 70° C. in light of both the image transfer performance and the heat and friction resistance of the obtained image.

The thermal image transfer recording medium according to the present invention comprises a support and a thermal transfer layer formed thereon, as previously mentioned.

As the support of the thermal image transfer recording medium, any conventional films and sheets of paper may be used. For example, there can be preferably employed a plastic film with relatively high heat resistance, such as a film made of polyester, e.g., polyethylene terephthalate, polycarbonate, trace cellulose, nylon or polyimide; a cellophane film; and parchment paper.

The thermal image transfer recording medium of the present invention may further comprise a protective layer which is provided on the back side of the support, opposite to the thermal transfer layer with respect to the support.

The protective layer serves to protect the support from high temperature when thermal energy is applied thereto using the thermal head. Therefore, not only various thermoplastic resins and thermosetting resins with high heat resistance, but also ultraviolet-curing resins and electron radiation curing resins can be used for the preparation of the protective layer. Preferable examples of the resin used for the preparation of the protective layer are fluoroplastics, silicone resin, polyimide resin, epoxy resin, phenolic resin and melamine resin. Such a resin may be formed into a thin film to form the protective layer on the back side of the support. The heat resistance of the support can be remarkably improved by the provision of the protective layer, so that a material which is considered to be unsuitable for the support can be used for the support.

The thermal transfer layer of the recording medium comprises a coloring agent and a thermoplastic resin. The thermal transfer layer may be prepared by laminating two or more thermal transfer layers.

The coloring agent for use in the thermal transfer layer may be appropriately chosen from carbon black, organic pigments, inorganic pigments and a variety of dyes according to the desired color tone of images.

The amount of the coloring agent is not particularly limited, but is preferably in the range of 10 to 50 wt. % of the total weight of the thermal transfer layer so as to improve the friction resistance of the obtained image.

The thermoplastic resin is added to the thermal transfer layer in order to adjust the dynamic elasticity modulus of the obtained recording medium within the predetermined range and impart the friction resistance and the heat resistance to the obtained image. In particular, a thermoplastic resin which can exhibit adhesion to the image receiving member is preferably used in the present invention.

Specific examples of the thermoplastic resin for use in the thermal transfer layer include ethylene-vinyl acetate copolymer, ethylene-ethyl acrylate copolymer, polyamide, polyester, polyurethane, polyvinyl chloride, a variety of cellulose derivatives, polystyrene, polyvinyl butyral, phenolic resin, epoxy resin, acrylic resin, and polyolefin resin; and modified materials thereof.

In the present invention, it is preferable that the glass transition temperature of the thermoplastic resin for use in the thermal transfer layer be 30° C. or more.

In view of the glass transition temperature, it is preferable that the thermoplastic resin for use in the thermal transfer layer comprise a polyester resin and/or an acrylic resin so as to improve the fixing performance of the image transferred to the image receiving member and the friction resistance and the heat resistance of the thus formed image.

The polyester resin for use in the present invention can be obtained by subjecting a polyvalent carboxylic acid and a polyhydric alcohol to random copolymerization.

Examples of the polyvalent carboxylic acid include aromatic dicarboxylic acids such as terephthalic acid, isophthalic acid, orthophthalic acid, 2,6-naphthalene-dicarboxylic acid and paraphenylenedicarboxylic acid; straight-chain aliphatic dicarboxylic acids such as succinic acid, glutaric acid, adipic acid, suberic acid, azelaic acid, sebacic acid and dodecanedioic acid; trimellitic acid; sodium sulfoisophthalate; and 1,4-cyclohexanedicarboxylic acid.

Examples of the polyhydric alcohol include ethylene glycol, 1,2-propylene glycol, 1,4-butanediol, 1,5-pentanediol, 1,6-hexanediol, neopentyl glycol, diethylene glycol, triethylene glycol, polyethylene glycol, polytetramethylene glycol, 1,4-cyclohexanedimethanol, trimethylolpropane, pentaerythritol and an adduct of bisphenol A with ethylene oxide.

At least one polyvalent carboxylic acid and polyhydric alcohol may be appropriately chosen so that the proper adhesion to the image receiving member may be imparted to the obtained thermoplastic resin, the obtained thermoplastic resin may have a predetermined glass transition temperature, and the thus prepared recording medium may show the previously mentioned dynamic elasticity modulus. In the case where the polyester resin is used for the thermal transfer layer, the dynamic elasticity modulus of the recording medium can be easily controlled within the previously mentioned range by adjusting the number-average molecular weight of the obtained polyester resin in the range of 300 to 20,000 in the course of polymerization.

Furthermore, the acrylic resin serving as the thermoplastic resin in the thermal transfer layer can be obtained by copolymerization of one or more monomers having vinyl group.

As the vinyl-group-containing monomer, there can be employed acrylonitrile, methacrylonitrile, alkyl acrylate, alkyl methacrylate, glycidyl acrylate, glycidyl methacrylate, styrene, styrene derivative and alkylhydroxy methacrylate are employed. One or more vinyl-group-containing monomers may be appropriately selected. It is preferable that the number-average molecular weight of the obtained acrylic resin be in the range of 1,000 to 10,000.

It is preferable that amount of the thermoplastic resin be in the range of 40 to 90 wt. %, more preferably 60 to 90 wt. %, of the total weight of the thermal transfer layer.

The thermal transfer layer may further comprise a thermofusible material for the purpose of improving the viscoelasticity of the thermal transfer layer. In such a case, it is preferable that the thermofusible material with a melting point of 50 to 120° C. be contained in an amount of 0 to 30 wt. % of the total weight of the thermal transfer layer.

Furthermore, to make the surface of the thermal transfer layer rough, a filler such as polyethylene, silica, alumina or calcium carbonate may be added to the thermal transfer layer. It is important to control the amount of filler to be added to the thermal transfer layer so as not to decrease the shear strength of the thermal transfer layer. The amount of filler may be 10 wt. % or less of the total weight of the thermal transfer layer.

Further, to improve the release characteristics of the thermal transfer layer from the support during the thermal image transfer operation, the thermal image transfer recording medium of the present invention may further comprise a release layer which is provided between the support and the thermal transfer layer. The release layer may be melted into a low-viscosity liquid when heated by the thermal head, and the release layer may be easily sheared at the interface between the heated portion and the non-heated portion.

Any wax that is hard at room temperature and fused by the application of heat thereto is preferably employed for the preparation of the release layer.

Specific examples of the wax include natural waxes such as beeswax, carnauba wax, whale wax, Japan wax, candelilla wax, rice wax and montan wax; synthetic waxes such as paraffin wax, microcrystalline wax, oxidized wax, ozokerite, ceresine wax, ester wax and polyethylene wax; higher saturated fatty acids such as margaric acid, lauric acid, myristic acid, palmitic acid, stearic acid, fromic acid and behenic acid; higher alcohols such as stearyl alcohol and behenyl alcohol; higher saturated esters such as fatty acid esters of sorbitan; and higher fatty acid amides such as stearic amide and oleic amide.

In addition, the release layer may further comprise an unvulcanized rubber such as isoprene rubber, butadiene rubber, ethylene propylene rubber, butyl rubber or nitrile rubber for providing the release layer with flexibility and adhesion to the support, and improving the peeling strength. Further, the release layer may further comprise a resin, for example, a polyolefin resin such as ethylene-vinyl acetate copolymer or ethylene-ethyl acrylate copolymer, polyamide resin, polyurethane resin, polyester resin, polyacrylic resin, cellulose resin, polyvinyl alcohol resin, petroleum resin, phenolic resin and polystyrene resin; and a tackifier.

Those materials may be appropriately used in combination for the preparation of the release layer.

In the release layer, it is preferable that the amount of the wax be in the range of 50 to 100 wt. %, more preferably 80 to 100 wt. %, of the total weight of the release layer.

The previously mentioned shear strength and peeling strength of the thermal transfer layer may vary depending on the drying conditions in the formation of the thermal transfer layer and the release layer. Therefore, such drying conditions may be controlled so that the desired shear strength and peeling strength can be imparted to the thermal transfer layer.

When the release layer is interposed between the support and the thermal transfer layer, an adhesive layer may be provided between the support and the release layer in order to further increase the shear strength of the thermal transfer layer at room temperature.

The adhesive layer may comprise any material that can fixedly binding the wax for use in the release layer to the support at room temperature and has no effect on the peeling strength of the thermal transfer layer when the thermal transfer layer is peeled and transferred.

Specific examples of such a material for use in the adhesive layer include unvulcanized rubber such as isoprene rubber, butadiene rubber, ethylene propylene rubber, butyl rubber or nitrile rubber; polyolefin resin such as ethylene-vinyl acetate copolymer or ethylene-ethyl acrylate copolymer; polyurethane resin; polyacrylic resin; cellulose resin; phenolic resin; and petroleum resin. Those materials may be subjected to cross-linking by use of a proper crosslinking agent so as to prevent the composition of the adhesive layer from mingling with the composition of the release layer.

Further, it is preferable to make the adhesive layer rough for increasing the interface between the adhesive layer and the release layer. For this purpose, an inorganic filler such as carbon black, graphite, calcium carbonate or titanium oxide, and an organic filler such as vinyl chloride powder may be dispersed in the adhesive layer.

The thermal transfer layer can be provided on the support or the release layer by hot melt coating, coating an aqueous coating liquid, or coating a coating liquid using an organic solvent.

It is preferable that the thickness of the thus prepared thermal image transfer recording medium of the present invention be in the range of 0.1 to 10 μm, and more preferably in the range of 0.5 to 6.0 μm.

It is preferable that the thickness of the thermal transfer layer be in the range of 0.5 to 6.0 μm, more preferably in the range of 0.8 to 3 μm.

It is preferable that the thickness of the release layer be in the range of 0.2 to 3.0 μm, and more preferably in the range of 1.0 to 2.0 μm.

It is preferable that the thickness of the adhesive layer be in the range of 0.05 to 2 μm, and more preferably in the range of 0.1 to 0.5 μm.

Other features of this invention will become apparent in the course of the following description of exemplary embodiments, which are given for illustration of the invention and are not intended to be limiting thereof.

### EXAMPLE 1

[Formation of Heat-resistant Protective Layer]

The following components were mixed to prepare a coating liquid for a heat-resistant protective layer:

| | Parts by weight |
|---|---|
| Silicone rubber “SD7226” | 3 |
| (Trademark) made by | |
| Dow Corning Toray Silicone | |
| Co., Ltd. | |
| Curing agent “SRX-212” | 0.05 |
| (Trademark) made by | |
| Dow Corning Toray Silicone | |
| Co., Ltd. | |
| Toluene | 97 |

On one side of a 1.5-μm thick polyester film, the above prepared coating liquid was coated and dried, so that a heat-resistant protective layer with a thickness of 0.1 μm was provided on the support.

[Formation of Adhesive Layer]

A coating liquid for an adhesive layer consisting of 100 parts by weight of an ethylene-vinyl acetate copolymer containing a vinyl acetate component in an amount of 46% and having a melt flow rate of 2.5 dg/cm² when measured by JIS K 6730 was coated on the other side of the polyester film, opposite to the above prepared protective layer, whereby an adhesive layer with a thickness of 0.2 μm was provided on the support.

[Formation of Release Layer]

A coating liquid for a release layer consisting of 50 parts by weight of carnauba wax and 50 parts by weight of candelilla wax was coated on the above prepared adhesive layer, whereby a release layer with a thickness of 1.0 μm was provided on the adhesive layer.

[Formation of Thermal Transfer Layer]

A mixture of the following components was dispersed in a ball mill for 10 hours to prepare a coating liquid (1):

Coating liquid (1)

| | Parts by Weight |
|---|---|
| Carbon black | 3 |
| Ethylene - vinyl acetate | 16 |
| copolymer | |
| (Melt flow rate: 15 dg/cm² | |
| Tg: 5° C.) | |
| Hydrogenated terpene resin | 1 |
| (Softening point: 90° C.) | |
| Toluene | 80 |

The thus prepared coating liquid (1) was coated on the above prepared release layer and dried at 50° C., so that a thermal transfer layer with a thickness of 1.5 μm was provided on the release layer.

Thus, a thermal image transfer recording medium No. 1 according to the present invention was obtained.

The dynamic elasticity modulus of the obtained recording medium No. 1, and the shear strength and the peeling strength of the thermal transfer layer were measured at 70° C. The results are shown in Table 1.

### EXAMPLE 2

The procedure for preparation of the thermal image transfer recording medium No. 1 in Example 1 was repeated except that the coating liquid (1) used for the formation of the thermal transfer layer in Example 1 was replaced by a coating liquid (2) with the following formulation:

Coating liquid (2)

| | Parts by weight |
|---|---|
| Carbon black | 3 |
| Polyester resin | 17 |
| (Tg: 40° C. | |
| Mn: 15,000) | |
| Methyl ethyl ketone | 40 |
| Toluene | 40 |

Thus, a thermal image transfer recording medium No. 2 according to the present invention was obtained.

The dynamic elasticity modulus of the obtained recording medium No. 2, and the shear strength and the peeling strength of the thermal transfer layer were measured at 70° C. The results are shown in Table 1.

### EXAMPLE 3

The procedure for preparation of the thermal image transfer recording medium No. 1 in Example 1 was repeated except that the coating liquid (1) used for the formation of the thermal transfer layer in Example 1 was replaced by a coating liquid (3) with the following formulation:

Coating liquid (3)

| | Parts by Weight |
|---|---|
| Carbon black | 3 |
| Polyester resin | 17 |
| (Tg: 36° C. | |
| Mn: 5,500) | |
| Methyl ethyl ketone | 40 |
| Toluene | 40 |

Thus, a thermal image transfer recording medium No. 3 according to the present invention was obtained.

The dynamic elasticity modulus of the obtained recording medium No. 3, and the shear strength and the peeling strength of the thermal transfer layer were measured at 70° C. The results are shown in Table 1.

### EXAMPLE 4

The procedure for preparation of the thermal image transfer recording medium No. 1 in Example 1 was repeated except that the coating liquid (1) used for the formation of the thermal transfer layer in Example 1 was replaced by a coating liquid (4) with the following formulation:

Coating liquid (4)

| | Parts by Weight |
|---|---|
| Carbon black | 3 |
| Acrylonitrile/methyl methacrylate/ | 17 |
| butyl methacrylate copolymer | |
| (Tg: 70° C. | |
| Mn: 6,000) | |
| Methyl ethyl ketone | 80 |

Thus, a thermal image transfer recording medium No. 4 according to the present invention was obtained.

The dynamic elasticity modulus of the obtained recording medium No. 4, and the shear strength and the peeling strength of the thermal transfer layer were measured at 70° C. The results are shown in Table 1.

### EXAMPLE 5

[Formation of Heat-resistant Protective Layer]

The same heat-resistant protective layer as in Example 1 was provided on one side of a 1.5-μm thick polyester film.

[Formation of Release Layer]

The following components were mixed to prepare a coating liquid for a release layer:

| | Parts by Weight |
|---|---|
| Carnauba wax | 90 |
| Polyester resin | 5 |
| (Tg: 36° C. | |
| Mn: 25,000) | |

The above prepared coating liquid for the release layer was coated on the other side of the polyester film, opposite to the heat-resistant protective layer, and dried, whereby a release layer with a thickness of 1.0 μm was provided on the support.

[Formation of Thermal Transfer Layer]

A mixture of the following components was dispersed in a ball mill for 10 hours to prepare a coating liquid (3):

Coating liquid (3)

| | Parts by Weight |
|---|---|
| Carbon black | 3 |
| Polyester resin | |
| (Tg: 5° C. | |
| Mn: 5,500) | 17 |
| Methyl ethyl ketone | 40 |
| Toluene | 40 |

The thus prepared coating liquid (3) was coated on the above prepared release layer and dried at 50° C., so that a thermal transfer layer with a thickness of 1.5 μm was provided on the release layer.

Thus, a thermal image transfer recording medium No. 5 according to the present invention was obtained.

The dynamic elasticity modulus of the obtained recording medium No. 5, and the shear strength and the peeling strength of the thermal transfer layer were measured at 70° C. The results are shown in Table 1.

### EXAMPLE 6

The procedure for preparation of the thermal image transfer recording medium No. 3 in Example 3 was repeated except that the ethylene-vinyl acetate copolymer used for the formation of the adhesive layer in Example 3 was replaced by an ethylene-ethyl acrylate copolymer containing an ethyl acrylate component in an amount of 12% and having a melt flow rate of 5 dg/cm².

Thus, a thermal image transfer recording medium No. 6 according to the present invention was obtained.

The dynamic elasticity modulus of the obtained recording medium No. 6, and the shear strength and the peeling strength of the thermal transfer layer were measured at 70° C. The results are shown in Table 1.

### EXAMPLE 7

The procedure for preparation of the thermal image transfer recording medium No. 3 in Example 3 was repeated except that the ethylene-vinyl acetate copolymer used for the formation of the adhesive layer in Example 3 was replaced by an acrylonitrile-butadiene copolymer with a molecular weight of 280,000.

Thus, a thermal image transfer recording medium No. 7 according to the present invention was obtained.

The dynamic elasticity modulus of the obtained recording medium No. 7, and the shear strength and the peeling strength of the thermal transfer layer were measured at 70° C. The results are shown in Table 1.

### Comparative Example 1

The procedure for preparation of the thermal image transfer recording medium No. 1 in Example 1 was repeated except that the coating liquid (1) used for the formation of the thermal transfer layer in Example 1 was replaced by a coating liquid (5) with the following formulation:

Coating liquid (5)

| | Parts by Weight |
|---|---|
| Carbon black | 3 |
| Styrene - acrylonitrile | 17 |
| copolymer | |
| (Tg: 90° C. | |
| Mn: 20,000) | |
| Methyl ethyl ketone | 80 |

Thus, a comparative thermal image transfer recording medium No. 1 was obtained.

The dynamic elasticity modulus of the obtained comparative recording medium No. 1, and the shear strength and the peeling strength of the thermal transfer layer were measured at 70° C. The results are shown in Table 1.

### Comparative Example 2

The procedure for preparation of the thermal image transfer recording medium No. 1 in Example 1 was repeated except that the coating liquid (1) used for the formation of the thermal transfer layer in Example 1 was replaced by a coating liquid (6) with the following formulation:

Coating liquid (6)

| | Parts by Weight |
|---|---|
| Carbon black | 6 |
| Ethylene - vinyl acetate | |
| copolymer | |
| (Melt flow rate: 150 dg/cm²) | 8 |
| Paraffin wax | |
| (Melting point: 61° C.) | 6 |
| Toluene | 80 |

Thus, a comparative thermal image transfer recording medium No. 2 was obtained.

The dynamic elasticity modulus of the obtained comparative recording medium No. 2, and the shear strength and the peeling strength of the thermal transfer layer were measured at 70° C. The results are shown in Table 1.

TABLE 1

| | Dynamic | Shear | Peeling |
|---|---|---|---|
| | Elasticity | Strength | Strength |
| | Modulus | (g/cm) | (g/cm) |
| Ex. 1 | 2 × 10⁷ | 40 | 38 |
| Ex. 2 | 1 × 10⁹ | 60 | 48 |
| Ex. 3 | 2 × 10⁸ | 37 | 32 |
| Ex. 4 | 1.3 × 10⁹ | 52 | 43 |
| Ex. 5 | 1.4 × 10⁸ | 38 | 32 |
| Ex. 6 | 3 × 10⁸ | 37 | 32 |
| Ex. 7 | 2 × 10⁸ | 40 | 39 |
| Comp. | 1.5 × 10¹⁰ | 66 | 55 |
| Ex. 1 | | | |
| Comp. | 8 × 10⁵ | 36 | 32 |
| Ex. 2 | | | |

A thermal printing test was conducted in such a manner that each of the above prepared thermal image transfer recording media No. 1 to No. 7 according to the present invention and comparative thermal image transfer recording media No. 1 and No. 2 was set in a thermal printing tester equipped with a commercially available edge type thermal head (made by Rohm Co., Ltd.) with a length of 13 cm. In this case, the distance A as shown in FIG. 4B was set to 210 μm. Thermal printing was carried out on two kinds of image receiving members, that is, a commercially available white PET label sheet (made by Lintec Co., Ltd.) and a commercially available coat paper TPKB (Trademark), made by Osaka Sealing Printing Co., Ltd., with a surface smoothness of 600 sec under such conditions that the pressure applied to the image receiving member and the recording medium was 200 g/cm² and the printing speed was 152 mm/sec.

In the thermal printing tester, each recording medium was pulled up to wind around a core with a radius of 1.4 cm after the completion of thermal transferring. The tension applied to the recording medium was controlled to the following two modes:

(1) Applied tension: 43 g/cm (Torque of the core shaft: 602 g·cm)

(2) Applied tension: 78 g/cm (Torque of the core shaft: 1,092 g·cm)

It took 1.4 msec for the recording medium to separate from the image receiving member after the application of thermal energy to the recording medium for the thermal printing operation was completed.

In the thermal printing test, parallel bar code images consisting of 10 characters, with a narrow width of 2 dots and a wide width of 5 dots in accordance with CODE 39 were printed on the two kinds of image receiving members. Then, the following evaluations were carried out:

1. Image Transfer Performance

The transferred bar code images were read by a commercially available pen scanner SD-3000″ (Trademark), made by Optoelectronics Co., Ltd. The image transfer performance was evaluated on the following scale:

◯: All bar code images were satisfactorily read by the pen scanner.

Δ: There were partially observed void portions in the bar code images, but all the bar code images were read by the pen scanner.

×: No bar code image was transferred to the image receiving member.

2. Friction Resistance of Transferred Image

The above-mentioned pen scanner was caused to rub against the bar code images formed on each image receiving member 2,000 times. Then, the friction resistance of the transferred image was evaluated on the following scale:

◯: There was no image blur.

Δ: A part of the bar code images became blurred, but reading by the pen scanner was possible.

×: The bar code images formed on the image receiving member partially chipped off, so that reading by the pen scanner was impossible.

3. Heat Resistance of Transferred Image

A piece of corrugated cardboard was caused to rub against the bar code images formed on each image receiving member 50 times with the application of a load of 20 g/cm² to the bar code images in an atmosphere of 80° C. Then, the heat resistance of the transferred image was evaluated on the following scale:

◯: There was no image blur.

Δ: A part of the bar code images became blurred, but reading by the pen scanner was possible.

×: The bar code images formed on the image receiving member partially chipped off, so that reading by the pen scanner was impossible.

The results are shown in Table 2.

TABLE 2

| | | | | | | | | | Comp. | Comp. |
|---|---|---|---|---|---|---|---|---|---|---|
| Example No. | | Ex. 1 | Ex. 2 | Ex. 3 | Ex. 4 | Ex. 5 | Ex. 6 | Ex. 7 | Ex. 1 | Ex. 2 |
| Tension | | 43 g/cm | | | | | | | | |
| Image | White | ◯ | X | ◯ | X | ◯ | ◯ | ◯ | X | X |
| Transfer | PET | | | | | | | | | |
| Perfor- | film | | | | | | | | | |
| mance | Coat | ◯ | X | ◯ | X | ◯ | ◯ | ◯ | X | ◯ |
| | paper | | | | | | | | | |
| Friction | | X | — | ◯ | — | ◯ | ◯ | ◯ | — | X |
| Resistance of | | | | | | | | | | |
| Image | | | | | | | | | | |
| Heat Resistance | | X | — | ◯ | — | ◯ | ◯ | ◯ | — | X |
| of Image | | | | | | | | | | |
| Tension | | 78 g/cm | | | | | | | | |
| Image | White | ◯ | ◯ | ◯ | ◯ | ◯ | ◯ | ◯ | X | X |
| Transfer | PET | | | | | | | | | |
| Perfor- | film | | | | | | | | | |
| mance | Coat | ◯ | Δ | ◯ | ◯ | ◯ | ◯ | ◯ | X | ◯ |
| | paper | | | | | | | | | |

| | | | | | | | | | |
|---|---|---|---|---|---|---|---|---|---|
| Friction | X | ◯ | ◯ | ◯ | ◯ | ◯ | ◯ | — | X |
| Resistance of | | | | | | | | | |
| Image | | | | | | | | | |
| Heat Resistance | X | ◯ | ◯ | ◯ | ◯ | ◯ | ◯ | — | X |
| of Image | | | | | | | | | |

The period of time from the completion of the application of thermal energy to the recording medium to the separation of the recording medium from the image receiving member was extended to 19.7 msec by attaching a plate to the edge of the thermal head so that the distance A as shown in FIG. 4B might be longer by 3 mm.

Then, the same evaluations as mentioned above were carried out.

The results are shown in Table 3.

TABLE 3

| | | | | | | | | | Comp. | Comp. |
|---|---|---|---|---|---|---|---|---|---|---|
| Example No. | | Ex. 1 | Ex. 2 | Ex. 3 | Ex. 4 | Ex. 5 | Ex. 6 | Ex. 7 | Ex. 1 | Ex. 2 |
| Tension | | 43 g/cm | | | | | | | | |
| Image | White | ◯ | X | ◯ | X | ◯ | ◯ | ◯ | X | X |
| Transfer | PET | | | | | | | | | |
| Perfor- | film | | | | | | | | | |
| mance | Coat | Δ | X | Δ | X | Δ | Δ | Δ | X | Δ |
| | paper | | | | | | | | | |
| Friction | | X | — | ◯ | — | ◯ | ◯ | ◯ | — | X |
| Resistance of | | | | | | | | | | |
| Image | | | | | | | | | | |
| Heat Resistance | | X | — | ◯ | — | ◯ | ◯ | ◯ | — | X |
| of Image | | | | | | | | | | |
| Tension | | 78 g/cm | | | | | | | | |
| Image | White | ◯ | ◯ | ◯ | ◯ | ◯ | ◯ | ◯ | X | X |
| Transfer | PET | | | | | | | | | |
| Perfor- | film | | | | | | | | | |
| mance | Coat | Δ | X | ◯ | Δ | Δ | ◯ | ◯ | X | Δ |
| | paper | | | | | | | | | |

| | | | | | | | | | |
|---|---|---|---|---|---|---|---|---|---|
| Friction | X | ◯ | ◯ | ◯ | ◯ | ◯ | ◯ | — | X |
| Resistance of | | | | | | | | | |
| Image | | | | | | | | | |
| Heat Resistance | X | ◯ | ◯ | ◯ | ◯ | ◯ | ◯ | — | X |
| of Image | | | | | | | | | |

As previously explained, since the dynamic elasticity modulus of the thermal image transfer recording medium is in the range of 1×10⁶ to 1×10¹⁰ at 70° C., the image transfer performance is satisfactory, and sharp images can be formed on an image receiving member such as a coat paper with a low surface smoothness.

In addition, the above-mentioned effects can be further improved by making the tension applied to the thermal image transfer recording medium larger than both the peeling strength and the shear strength of the thermal transfer layer of the thermal image transfer recording medium.

When the thermal transfer layer of the thermal image transfer recording medium comprises a thermoplastic resin with a glass transition temperature of 30° C. or more, and the above-mentioned thermoplastic resin comprises a polyester resin and/or an acrylic resin, the image transferred to an image receiving member is excellent in terms of the friction resistance and the heat resistance.

Japanese Patent Application No. 08-344576 filed Dec. 9, 1996, and Japanese Patent Application filed Dec. 4, 1997 (its filing number is not yet available) are hereby incorporated by reference.

What is claimed is:

1. A thermal image transfer recording method comprising the step of:
holding a thermal image transfer recording medium comprising a support and a thermal transfer layer formed thereon and an image receiving member between an edge thermal head for use in a line printer and a platen roller in such a fashion that said thermal transfer later of said recording medium comes in contact with said image receiving member with the applications of a tension to said thermal image transfer recording medium, and
transferring an image from said thermal transfer layer of said recording medium to said image receiving member by the application of heat to said recording medium using said thermal head, said thermal image transfer recording medium having a dynamic elasticity modulus in a range of 1×10⁶ to 1×10¹⁰ at 70° C.

2. The thermal image transfer recording method as claimed in claim 1, wherein said tension applied to said thermal image transfer recording medium is larger than the peeling strength and the shear strength of said thermal transfer layer of said thermal image transfer recording medium, both of which are measured at 70° C.

3. The thermal image transfer recording method as claimed in claim 1, further comprising the step of separating said thermal image transfer recording medium from said image-bearing image receiving member after said transferring step.

4. The thermal image transfer recording method as claimed in claim 3, wherein said thermal image transfer recording medium is separated from said image-bearing image receiving member within five msec after the completion of said transferring step.

5. A thermal image transfer recording medium which comprises a support and a thermal transfer layer formed thereon, and has a dynamic elasticity modulus in a range of 1×10⁶ to 1×10¹⁰ at 70° C.

6. The thermal image transfer recording medium as claimed in claim 5, wherein said thermal transfer layer comprises a thermoplastic resin with a glass transition temperature of 30° C. or more.

7. The thermal image transfer recording medium as claimed in claim 6, wherein said thermoplastic resin comprises at least one resin component selected from the group consisting of a polyester resin and an acrylic resin.

8. The thermal image transfer recording medium as claimed in claim 5, further comprising a release layer which is provided between said support and said thermal transfer layer.

9. The thermal image transfer recording medium as claimed in claim 8, further comprising an adhesive layer which is provided between said support and said release layer.

10. The thermal image transfer recording medium as claimed in claim 9, wherein said adhesive layer comprises at least one component selected from the group consisting of ethylene-vinyl acetate copolymer resin, ethylene-ethyl acrylate copolymer resin, and unvulcanized rubber.
